(19) United States
(12) Patent Application Publication
(10) Pub. No.: US 2021/0140097 A1
(43) Pub. Date: May 13, 2021

(54) ANTIFOULING PROCESSING AGENT COMPOSITION, AND ARTICLES AND TEXTILE PRODUCTS TREATED BY USING THE SAME

(71) Applicant: AGC Inc., Tokyo (JP)

(72) Inventors: Hiroyuki HARA, Tokyo (JP); Kazunori SUGIYAMA, Tokyo (JP); Yujiro TOMIZUKA, Tokyo (JP); Katsuyuki TSUGITA, Chigasaki-shi (JP); Masataka JINPACHI, Chigasaki-shi (JP)

(73) Assignee: AGC Inc., Tokyo (JP)

(21) Appl. No.: 17/155,403

(22) Filed: Jan. 22, 2021

Related U.S. Application Data
(63) Continuation of application No. PCT/JP2019/039375, filed on Oct. 4, 2019.

(30) Foreign Application Priority Data
Oct. 9, 2018 (JP) 2018-191293

(51) Int. Cl. D06M 15/277; C09K 3/18; D06M 13/02; D06M 13/428

(52) U.S. Cl. CPC D06M 15/277; D06M 13/428; D06M 13/02; C09K 3/18

(57) ABSTRACT

To provide an antifouling processing agent composition capable of imparting oil repellency and antifouling properties (stain release properties), while suppressing a reduction in the water absorbency of a textile product. This antifouling processing agent composition comprises: a fluorinated polymer comprising from 30 to 70 mass % of units based on F(CF₂)ₙY—OCOCR═CH₂ (wherein Y is an alkylene group, and R is a hydrogen atom, an alkyl group, or a halogen atom) and from 20 to 60 mass % of units based on CH₂═CR¹—COO—(R²O)_{q}—R³ (wherein R¹ is a hydrogen atom or a methyl group, R² is an alkylene group, and R³ is a hydrogen atom, an alkyl group, a (meth)acryloyl group, or a glycidyl group), and having a number average molecular weight of 3,000-500,000; and a fluorinated amphoteric surfactant having a C₁₋₆ perfluoroalkyl group or a C₃₋₉ perfluoroalkenyl group, and having a number average molecular weight of less than 3,000.

### TECHNICAL FIELD

The present invention relates to an antifouling processing agent composition, and articles and textile products treated with the antifouling processing agent composition.

### BACKGROUND ART

Heretofore, as an antifouling processing agent for textile products, a water-repellent oil-repellent antifouling agent provided with both water and oil repellency to prevent stains from sticking and antifouling properties (also referred to as stain release properties or SR properties) to make it easy to remove stains once adhered, by e.g. washing, has been known.

However, when water and oil repellency is imparted to textile products, water absorption tends to decrease, and, for example, in the case of clothing, it becomes difficult to absorb sweat, and inconveniences such as discomfort when worn are likely to result.

Therefore, as a treatment agent that imparts oil repellency and SR properties without lowering the water absorption of the textile product, Patent Document 1 discloses a fluorinated polymer obtained by polymerizing a monomer having a fluoroalkyl group or a fluoroalkenyl group, a monomer having an oxyalkylene group, a monomer having an acetoacetyl group, and a monomer having an acid group.

Further, Patent Document 2 discloses a composition comprising a fluorinated copolymer having units based on a monomer having a fluoroalkyl group and units based on a monomer having an oxyalkylene group, and not containing units based on a monomer having an amino group, and a blocked isocyanate compound.

### PRIOR ART DOCUMENTS

### Patent Documents

Patent Document 1: WO 2009/014038

Patent Document 2: WO 2012/133622

### DISCLOSURE OF INVENTION

### Technical Problem

However, the treatment agents described in Patent Documents 1 and 2 do not necessarily sufficiently satisfy both oil repellency and water absorption.

The present invention is to provide an antifouling processing agent composition capable of imparting oil repellency and SR properties while suppressing a decrease in water absorption of a textile product, and articles and textile products treated by using the same.

### Solution To Problem

The present invention has the following embodiments.

[1] An antifouling processing agent composition comprising a fluorinated polymer and a fluorinated amphoteric surfactant,

wherein the fluorinated polymer comprises, to the total amount of units based on monomers constituting the fluorinated polymer, from 30 to 70 mass % of units based on a monomer represented by the following formula (1) and from 20 to 60 mass % of units based on a monomer represented by the following formula (2), and has a number average molecular weight of from 3,000 to 500,000, and

the fluorinated amphoteric surfactant has a C₁₋₆ perfluoroalkyl group or a C₃₋₉ perfluoroalkenyl group, and has a number average molecular weight of less than 3,000:

F(CF₂)ₙY—OCOCR═CH₂ (1)

CH₂═CR¹—COO—(R²O)_{q}—R³ (2)

wherein n represents an integer of 1 to 6, Y represents a C₁₋₁₀ alkylene group, R represents a hydrogen atom, a C₁₋₃ alkyl group or a halogen atom, R¹ represents a hydrogen atom or a methyl group, and R² represents a C₂₋₄ alkylene group, R³ represents a hydrogen atom, a C₁₋₈ alkyl group, a (meth)acryloyl group or a glycidyl group, and q represents an integer of 1 to 140, and in a case where q is an integer of at least 2, the plurality of —(R²O)— may be the same as or different from each other.
[2] The antifouling processing agent composition according to [1], wherein the fluorinated polymer contains more than 0 mass % and at most 10 mass % of units based on at least one monomer selected from the group consisting of a monomer represented by the following formula (3) and a monomer represented by the following formula (4):

CH₂═CR⁴-M-Q-NR⁵R⁶ (3)

CH₂═CR⁴-M-Q-N(O)R⁵R⁶ (4)

wherein R⁴ represents a hydrogen atom or a methyl group, M represents —COO— or —CONH—, Q represents a C₂₋₄ alkylene group, or a C₂₋₃ alkylene group in which at least one of hydrogen atoms is substituted by a hydroxy group, and each of R⁵ and R⁶ independently represents a benzyl group, a C₁₋₈ alkyl group, or a C₂₋₃ alkyl group in which at least one of hydrogen atoms is substituted by a hydroxy group.
[3] The antifouling processing agent composition according to [1] or [2], wherein the monomer represented by the formula (2) is a monomer in which the oxyalkylene group represented by the above (R²O) is an oxyethylene group.
[4] The antifouling processing agent composition according to [1] or [2], wherein the monomer represented by the formula (2) is a monomer containing, as the oxyalkylene group represented by the above (R²O), an oxyethylene group and an oxytetramethylene group.
[5] The antifouling processing agent composition according to any one of [1] to [4], wherein said fluorinated polymer is a fluorinated polymer comprising units based on a monomer in which the above oxyalkylene group is an oxyethylene group and units based on a monomer in which the above oxyalkylene group is an oxyethylene group and an oxytetramethylene group.
[6] The antifouling processing agent composition according to [5], wherein the proportion of the units based on the monomer in which the oxyalkylene group is an oxyethylene group and an oxytetramethylene group, is from 20 to 60 mass %, to the total of the units based on the monomer in which the oxyalkylene group is an oxyethylene group, and the units based on the monomer in which the oxyalkylene group is an oxyethylene group and an oxytetramethylene group.
[7] The antifouling processing agent composition according to any one of [1] to [6], wherein the mass ratio of the fluorinated polymer to the fluorinated amphoteric surfactant represented by the fluorinated polymer/fluorinated amphoteric surfactant, is from 1/1 to 5/1.
[8] The antifouling processing agent composition according to any one of [1] to [7], wherein the specific gravity of the fluorinated amphoteric surfactant is from 1.10 to 1.80.
[9] The antifouling processing agent composition according to any one of [1] to [8], which comprises the fluorinated polymer and the fluorinated amphoteric surfactant such that the absolute value of the difference between the contact angle of water in a PET film whose surface is treated with the fluorinated polymer and the contact angle of water in a PET film whose surface is treated with the fluorinated amphoteric surfactant, is at least 50.
[10] The antifouling processing agent composition according to any one of [1] to [9], which comprises the fluorinated polymer and the fluorinated amphoteric surfactant such that the absolute value of the difference between the contact angle of n-hexadecane in a PET film whose surface is treated with the fluorinated polymer and the contact angle of n-hexadecane in a PET film whose surface is treated with the fluorinated amphoteric surfactant, is at most 10.
[11] An article treated with the antifouling processing agent composition as defined in any one of [1] to [10].
[12] A textile product treated with the antifouling processing agent composition as defined in any one of [1] to [10].

### Advantageous Effects of Invention

The antifouling processing agent composition of the present invention can impart oil repellency and SR properties while suppressing a decrease in water absorption of a textile product.

The article and textile product of the present invention are excellent in water absorption, oil repellency and SR properties.

### DESCRIPTION OF EMBODIMENTS

The meanings of the terms in the present specification are as follows.

A “unit based on a monomer” is a general term for an atomic group derived from one molecule of a monomer, directly formed by polymerizing the monomer, and an atomic group obtainable by chemically converting a part of the atomic group.

A “(meth)acrylate” is a general term for an acrylate and a methacrylate.

“(Meth)acryloyl” is a general term for acryloyl and methacryloyl.

A “(meth)acrylamide” is a general term for an acrylamide and a methacrylamide.

A “polyfluoroalkyl group” is a group in which some or all of hydrogen atoms in an alkyl group are substituted by fluorine atoms.

A “perfluoroalkyl group” is a group in which all hydrogen atoms in an alkyl group are substituted by fluorine atoms.

A “perfluoroalkenyl group” is a group in which all hydrogen atoms in an alkenyl group are substituted by fluorine atoms.

The “number average molecular weight” and “mass average molecular weight” of a fluorinated polymer are values obtained in terms of polyethylene oxide by the gel permeation chromatography (GPC) method. As GPC measurement conditions, TSKgel α-M (product name of Tosoh Corporation) was used as the column, and a solvent having 0.2 M lithium chloride added to a mixed solvent of AE3000 (1,1,2,2-tetrafluoroethyl-2,2,2-trifluoroethyl ether, product name of AGC Inc.)/methanol=50/50 volume %, was used as the mobile phase.

The “number average molecular weight” of a fluorinated amphoteric surfactant is a value obtained by the above-mentioned GPC method in a case where the fluorinated amphoteric surfactant is an oligomer. In a case where the fluorinated amphoteric surfactant is a single compound, it is a value (formula weight) calculated from the structural formula.

### Anti-Fouling Processing Agent Composition

### Fluorinated Polymer

The antifouling processing agent composition of the present invention contains a fluorinated polymer (hereinafter referred to as a polymer (A)) comprising units (hereinafter referred to as monomer (a) units; similarly hereinafter represented by adding “units” to a monomer name) based on a monomer represented by the following formula (1) (hereinafter referred to as a monomer (a)) and units (monomer (b) units) based on a monomer represented by the following formula (2) (hereinafter referred to as a monomer (b)).

F(CF₂)ₙY—OCOCR═CH₂ (1)

CH₂═CR¹—COO—(R²O)_{q}—R³ (2)

In the formula (1), n represents an integer of from 1 to 6, Y represents a C₁₋₁₀ alkylene group, and R represents a hydrogen atom, a C₁₋₃ alkyl group or a halogen atom.

In the formula (2), R¹ represents a hydrogen atom or a methyl group, R² represents a C₂₋₄ alkylene group, R³ represents a hydrogen atom, a C₁₋₈ alkyl group, a (meth)acryloyl group or a glycidyl group, and q represents an integer of from 1 to 140, and when q is an integer of at least 2, the plurality of —(R²O)— present in one molecule may be the same as or different from each other.

In the formula (1), n is preferably from 2 to 6, more preferably from 4 to 6, further preferably 4 or 6.

As Y, —CH₂—, —CH₂CH₂—, —(CH₂)₁₁— and CH₂CH₂CH(CH₃)— are preferred, and —CH₂CH₂— is more preferred.

The halogen atom as R is preferably a fluorine atom or a chlorine atom. R is more preferably a hydrogen atom, a methyl group or a chlorine atom.

As the monomer (a), 3,3,4,4,5,5,6,6,7,7,8,8,8-tridecafluorooctyl (meth)acrylate (C₆F₁₃C₂H₄OCOCH═CH₂, C₆F₁₃C₂H₄OCOC(CH₃)═CH₂), 3,3,4,4,5,5,6,6,6-nonafluorohexyl (meth)acrylate (C₄F₉C₂H₄OCOCH═CH₂, C₄F₉C₂H₄OCOC(CH₃)═CH₂), 2-chloro-3,3,4,4,5,5,6,6,7,7,8,8,8-tridecafluorooctyl acrylate (C₆F₁₃C₂H₄OCOC(Cl)═CH₂) and 2-chloro-3,3,4,4,5,5,6,6,6-nonafluorohexyl acrylate (C₄F₉C₂H₄OCOC(Cl)═CH₂) are preferred. As the monomer (a), two or more types may be used.

In the formula (2), as R¹, a methyl group is preferred. As q, from 1 to 137 is preferred, from 4 to 137 is more preferred, from 4 to 70 is further preferred, and from 6 to 30 is particularly preferred. As R³, a hydrogen atom and a methyl group are preferred.

As the oxyalkylene group represented by —(R²O)—, an oxyethylene group, an oxypropylene group and an oxytetramethylene group are preferred from the viewpoint of antifouling properties.

In the oxyalkylene chain represented by —(R²O)_{q}—, in a case where at least two types of —(R²O)— different in the number of carbon atoms are contained, the sequence of such a plurality of —(R²O)— may be a block form or a random form.

As the oxyalkylene chain represented by —(R²O)_{q}— wherein q is at least 2, an oxyalkylene chain in which the oxyalkylene groups represented by —(R²O)— are oxyethylene groups, an oxyalkylene chain in which they are oxyethylene groups and oxypropylene groups, and an oxyalkylene chain in which they are oxyethylene groups and oxytetramethylene groups, are more preferred, and an oxyalkylene chain in which they are oxyethylene groups, and an oxyalkylene chain in which they are oxyethylene groups and oxytetramethylene groups are further preferred.

In the following, —(R₂O)— being an oxyethylene group will be represented by -(EO)—, —(R₂O)— being an oxypropylene group will be represented by —(PO)—, and —(R₂O)— being an oxytetramethylene group will be represented by -(TO)—. Further, for example, an oxyalkylene chain having oxyethylene groups and oxytetramethylene groups will be represented by -((EO)_{q1}-(TO)_{q2})—. Here, q1 and q2 are integers of at least 1, respectively, and q1+q2=q. -((EO)_{q1}-(TO)_{q2})— is one representing an oxyalkylene chain containing q1 (EO) and q2 (TO), and is not one representing a sequence. As mentioned above, q1 (EO) and q2 (TO) may be a random form or a block form. The same applies to other oxyalkylene chains having at least two types of oxyalkylene groups.

The monomer (b) may, for example, be 2-hydroxyethyl (meth)acrylate, 3-hydroxybutyl (meth)acrylate, 4-hydroxybutyl (meth)acrylate, polyoxyethylene glycol mono(meth)acrylate (CH₂═CHCOO(EO)_{q}—H and CH₂═C(CH₃)COO(EO)_{q}—H), methoxypolyoxyethylene glycol (meth)acrylate (CH₂═CHCOO(EO)_{q}—CH₃ and CH₂═C(CH₃)COO(EO)_{q}—CH₃), polyoxypropylene glycol mono(meth)acrylate (CH₂═CHCOO(PO)_{q}—H and CH₂═C(CH₃)COO(PO)_{q}—H), methoxypolyoxypropylene glycol (meth)acrylate (CH₂═CHCOO(PO)_{q}—CH₃ and CH₂═C(CH₃)COO(PO)_{q}—CH₃), polyoxytetramethylene glycol mono(meth)acrylate (CH₂═CHCOO-(TO)_{q}—H and CH₂═C(CH₃)COO-(TO)_{q2}—H), or methoxypolyoxytetramethylene glycol (meth)acrylate (CH₂═CHCOO-(TO)_{q}—CH₃ and CH₂═C(CH₃)COO-(TO)_{q2}—CH₃). Poly(oxyethylene-oxypropylene) glycol mono(meth)acrylate (CH₂═CHCOO-((EO)_{q1}—(PO)_{q2})—H and CH₂═C(CH₃)COO-((EO)_{q1}—(PO)_{q2})—H), methoxypoly(oxyethylene-oxypropylene) glycol (meth)acrylate (CH₂═CHCOO-((EO)_{q1}—(PO)_{q2})—CH₃ and CH₂═C(CH₃)COO-((EO)_{q1}—(PO)_{q2})—CH₃), poly(oxyethylene-oxytetramethylene) glycol mono(meth)acrylate (CH₂═CHCOO-((EO)_{q1}-(TO)_{q2})—H and CH₂═C(CH₃)COO-((EO)_{q1}-(TO)_{q2})—H), or methoxypoly(oxyethylene-oxytetramethylene) glycol (meth)acrylate (CH₂═CHCOO-((EO)_{q1}-(TO)_{q2})—CH₃ and CH₂═C(CH₃)COO-((EO)_{q1}-(TO)_{q2})—CH₃) may be mentioned.

From such a viewpoint that oil repellency and SR properties will be more improved, the above CH₂═C(CH₃)COO(EO)_{q}CH₃ and the above CH₂═C(CH₃)COO-((EO)_{q1}-(TO)_{q2})—H are more preferred.

As the monomer (b), one type may be used alone, or two or more types may be used in combination.

In view of oil repellency and SR properties, the monomer (b) units in the polymer (A) preferably contain from 10 to 100 mass % of units based on a monomer in which the oxyalkylene chain is -((EO)_{q1}-(TO)_{q2})—, to the total mass of the monomer (b) units. By containing units based on a monomer in which the oxyalkylene chain is -((EO)_{q}-(TO)_{q2})—, the glass transition point of the polymer (A) is lowered, and the oil repellency and SR properties are improved.

In a case where the units based on the monomer in which the oxyalkylene chain is -((EO)_{q1}-(TO)_{q2})— is less than 100 mass %, it is preferred to contain, as another monomer (b) units, units based on a monomer in which the oxyalkylene chain is -(EO)_{q}—. The proportion of the units based on the monomer in which the oxyalkylene chain is -((EO)_{q1}-(TO)_{q2})—, to the total amount of these units, is preferably from 20 to 60 mass %, more preferably from 25 to 55 mass %.

To the total mass of units constituting the polymer (A), the monomer (a) units are from 30 to 70 mass %, and the monomer (b) units are from 20 to 60 mass %.

When the monomer (a) units are at least the lower limit value in the above range, the oil repellency will be excellent, and when they are at most the upper limit value, the SR properties will be excellent.

When the monomer (b) units are at least the lower limit value in the above range, the SR properties will be excellent, and when they are at most the upper limit value, the oil repellency will be excellent.

The monomer (a) units are preferably from 40 to 64 mass %, more preferably from 43 to 62 mass %, to the total mass of units constituting the polymer (A), in that oil repellency will be more excellent.

The monomer (b) units are preferably from 30 to 54 mass %, more preferably from 32 to 53 mass %, to the total mass of units constituting the polymer (A), in that SR properties will be more excellent.

The polymer (A) may further contain units based on at least one type of monomer selected from the group consisting of a monomer represented by the following formula (3) and a monomer represented by the following formula (4). Hereinafter, the monomer represented by the following formula (3) and the monomer represented by the following formula (4) may collectively be referred to also as a “monomer (c)”.

CH₂═CR⁴-M-Q-NR⁵R⁶ (3)

CH₂═CR⁴-M-Q-N(O)R⁵R⁶ (4)

In the formulae (3) and (4), R⁴ represents a hydrogen atom or a methyl group, M represents —COO— or —CONH—, Q is a C₂₋₄ alkylene group or a C₂₋₃ alkylene group in which at least one or all of hydrogen atoms are substituted by hydroxy groups, and R⁵ and R⁶ are each independently a benzyl group, a C₁₋₈ alkyl group or a C₂₋₃ alkyl group in which at least one or all of hydrogen atoms are substituted by hydroxy groups.

R⁵, R⁶ and the nitrogen atom may form a piperidino group or a pyrrolidinyl group, and R⁵, R⁶, the oxygen atom and the nitrogen atom may form a morpholino group.

In the formulae (3) and (4), M is preferably —COO—. Q is preferably a C₂₋₄ alkylene group. R⁵ and R⁶ are each independently preferably a C₁₋₄ alkyl group.

As the monomer represented by the formula (3), from such a viewpoint that the dispersibility in an aqueous medium as will be described later, and the adhesiveness to a textile product, will be more improved, N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-diisopropylaminoethyl (meth)acrylate, N,N-dimethylaminopropyl (meth)acrylamide, N-(meth)acryloylmorpholine and N-(meth)acryloylpepyridine are preferred, and N,N-dimethylaminoethyl methacrylate and N,N-diethylaminoethyl (meth)acrylate are more preferred.

As the monomer represented by the formula (3), from such a viewpoint that the dispersibility in an aqueous medium as will be described later, and the adhesiveness to a textile product, will be more improved, N,N-dimethylaminooxide ethyl (meth)acrylate, and N, N-diethylaminooxide ethyl (meth)acrylate are preferred.

In the polymer (A), the monomer (c) units are not essential, but when they are used, the dispersibility of the polymer (A) in an aqueous medium as described later, and the adhesion to a textile product, will be improved.

In a case where the monomer (c) is used, to the total mass of units constituting the polymer (A), the monomer (c) units are preferably more than 0 mass % and at most 10 mass %, more preferably from 0.5 to 6 mass %. Being at most the upper limit value in the above range is preferred from the viewpoint of SR properties.

The polymer (A) may have units based on a monomer (hereinafter referred to as a monomer (d)) which is a monomer other than the above monomers (a) to (c), in addition to the monomers (a) to (c), and which does not have a polyfluoroalkyl group and has a crosslinkable functional group. As the functional group, preferred is a functional group capable of forming a self-crosslinked structure in the polymer, a crosslinked structure between molecules of the polymer and another polymer, or a crosslinked structure with a reactive group on the surface of the substrate. As such a functional group, a hydroxy group, an isocyanate group, a blocked isocyanate group, an alkoxysilyl group, an acrylamide group, an epoxy group, an oxazoline group and a carbodiimide group may be exemplified. As the above functional group, a hydroxy group, a blocked isocyanate group, an alkoxysilyl group and an acrylamide group are preferred.

As the monomer (d), 2-hydroxybutyl (meth)acrylate, N-methylol (meth)acrylamide, N-methoxymethyl (meth)acrylamide, N-ethoxymethyl (meth)acrylamide, N-butoxymethyl (meth)acrylamide, diacetone acrylamide, glycidyl (meth)acrylate, glycerol (meth)acrylate, acetoacetoxyethyl (meth)acrylate, acetoacetoxypropyl (meth)acrylate, 3-chloro-2-hydroxypropyl (meth)acrylate, a 3,5-dimethylpyrazole adduct of 2-isocyanatoethyl (meth)acrylate, a methylethyl ketooxime adduct of 2-isocyanatoethyl (meth)acrylate, and a diethyl malonate adduct of 2-isocyanatoethyl (meth)acrylate are preferred from such a viewpoint that washing durability will be further improved.

In the polymer (A), the monomer (d) units are not essential, but when they are used, it tends to be easy to improve the washing durability.

In a case where the monomer (d) is used, the monomer (d) units are preferably more than 0 mass % and at most 5 mass %, more preferably from 0.5 to 4 mass %, to the total mass of the polymer (A). Being at most the upper limit value in the above range is preferred from such a viewpoint that the SR properties tend to be good.

The polymer (A) may have units based on a monomer (hereinafter referred to as a monomer (e)) other than the above monomers (a) to (d). As the monomer (e), monomers known in the field of fluorinated copolymers may be used, and for example, the monomers described in the specification of WO 2008/143299 may be used. To the total mass of units constituting the polymer (A), the monomer (e) units are preferably at most 10 mass %, more preferably at most 5 mass %, and may be zero.

The number average molecular weight of the polymer (A) is from 3,000 to 500,000, preferably from 10,000 to 400,000, more preferably from 30,000 to 300,000.

When it is at least the lower limit value in the above range, washing durability and oil repellency tend to be good, and when it is at most the upper limit value, SR properties and dispersion stability tend to be good.

The polymer (A) can be produced by a known method. For example, it is possible to apply the methods described in paragraphs 0065 to 0072 in JP-A-2018-83888.

### Fluorinated Amphoteric Surfactant

The antifouling processing agent composition of the present invention contains a fluorinated amphoteric surfactant. An amphoteric surfactant is a surfactant having a structure that can become a cation and a structure that can become an anion in one molecule at the same time, and the portion of the structure that can become an ion will be positively charged or negatively charged depending on the pH. As the amphoteric surfactant, a betaine-type surfactant may be mentioned. A betaine-type surfactant has a positive charge and a negative charge on non-adjacent atoms in the same molecule, and the atom having a positive charge takes a cationic structure such as quaternary ammonium, sulfonium, or phosphonium. A betaine-type surfactant is a compound that has no charge as a whole molecule. Further, as the amphoteric surfactant, a compound having a secondary or tertiary amine as a structure capable of becoming a cation and having a sulfonic acid group or a carboxylic acid group as a structure capable of becoming an anion, in one molecule, may be mentioned.

The fluorinated amphoteric surfactant has a C₁₋₆ perfluoroalkyl group or a C₃₋₉ perfluoroalkenyl group.

The perfluoroalkyl group may be linear or branched. Being linear is preferred.

The perfluoroalkenyl group may be linear or branched. Being branched is preferred.

As the fluorinated amphoteric surfactant, it is possible to employ a commercially available fluorinated amphoteric surfactant.

As the fluorinated amphoteric surfactant having a C₁₋₆ perfluoroalkyl group, Surflon S-231, Surflon S-232, Surflon S-233 and Surflon S-234 (all are product names of AGC Seimi Chemical Co., Ltd.), Capstone FS-50, Capstone FS-51, Capstone 1157D and Capstone 1470 (product names of The Chemours Company) may be exemplified.

As the fluorinated amphoteric surfactant having a C₃₋₉ perfluoroalkenyl group, Ftergent 400SW (product name of NEOS COMPANY LIMITED) may be exemplified.

The number average molecular weight of the fluorinated amphoteric surfactant is less than 3,000. It is preferably at least 400 and less than 3,000, more preferably from 450 to 2,000, further preferably from 500 to 1,000. When it is at least the lower limit value in the above range, washing durability and oil repellency tend to be good, and when it is at most the upper limit value, water absorption and SR properties tend to be good.

The specific gravity of the fluorinated amphoteric surfactant is preferably from 1.10 to 1.80, more preferably from 1.35 to 1.55. When it is at least the lower limit value in the above range, washing durability and oil repellency tend to be good, and when it is at most the upper limit value, water absorption and SR properties tend to be good.

Either a value obtained by measuring the specific gravity of a fluorinated amphoteric surfactant as a sample, or a value obtained by calculating the specific gravity of a fluorinated amphoteric surfactant from a measured value of a solution in which a fluorinated amphoteric surfactant is dissolved in a solvent having a known specific gravity, may be within the above range.

In a case where the contact angle of water is represented by Wx and the contact angle of n-hexadecane is represented by Hx in a PET film surface-treated by the following method using a fluorinated amphoteric surfactant, Wx being from 0 to 45 degrees and Hx being from 50 to 120 degrees, are preferred from such a viewpoint that water absorption, oil repellency and SR properties tend to be good. Said Wx being from 0 to 40 degrees and said Hx being from 60 to 90 degrees are more preferred.

Further, in a case where the contact angle of water is represented by Wy and the contact angle of n-hexadecane is represented by Hy in a PET film surface-treated by the following method using a polymer (A), the absolute value of the difference between Wx of the fluorinated amphoteric surfactant coexisting in the antifouling processing agent composition and Wy of the polymer (A) being at least 50 degrees and the absolute value of the difference between Hx and Hy being at most 10 degrees, are preferred from such a viewpoint that water absorption, oil repellency and SR properties tend to be good.

### Surface Treatment Method

2 g of a liquid obtained by diluting the fluorinated amphoteric surfactant (or the polymer (A)) to be measured, with water so as to have a solid content concentration of 20 mass %, 8 g of a polyvinyl butyral resin, and 40 g of ethanol are mixed to prepare a treatment liquid. After degreasing the surface of a 100 μm-thick PET film with ethanol, the treatment liquid is applied, heated at 80° C. for 20 minutes and then heated at 110° C. for 20 minutes to form a coating film having a thickness of at most 3 μm.

### Other Components

The antifouling processing agent composition may contain a cross-linking agent, a catalyst, etc. for improving the adhesiveness with the substrate material by cross-linking with the substrate material. Further, it may contain various other known additives.

As the cross-linking agent, an isocyanate-type cross-linking agent, a methylol-type cross-linking agent, a carbodiimide-type cross-linking agent, and an oxazoline-type cross-linking agent are preferred. Other known additives may be a fluorinated surfactant other than the above-mentioned fluorinated amphoteric surfactant (hereinafter referred to as a “fluorinated non-amphoteric surfactant”), a surfactant having no fluorine atom (hereinafter referred to as a “non-fluorinated surfactant”), a water-soluble polymer resin, a penetrant, silica, a defoamer, a film-forming aid, an insect repellent, a flame retardant, an antistatic agent, a wrinkle repellent, a flexible agent, a pH adjuster, etc. The water-soluble polymer resin may, for example, be a hydrophilic polyester resin such as MEIKAFINISH SRM-42T or MEIKAFINISH SRM-65 (each being a product name of Meisei Chemical Works, Ltd.), or a hydrophilic acrylic resin such as MEIKAFINISH SRO (a product name of Meisei Chemical Works, Ltd.).

In a case where the antifouling processing agent composition contains other surfactants (such as a fluorinated non-amphoteric surfactant, a non-fluorinated surfactant, etc.) in addition to the fluorinated amphoteric surfactant, their content is preferably at most 20 mass %, more preferably at most 10 mass %, to the total mass of the stain processing agent composition. The antifouling processing agent composition may not contain the above-mentioned other surfactants.

The antifouling processing agent composition of the present invention can be produced by a method of mixing the polymer (A) and the fluorinated amphoteric surfactant. Preferably, an aqueous dispersion of the polymer (A), and the fluorinated amphoteric surfactant, are mixed to produce an antifouling processing agent composition. Other components may also be mixed as the case requires.

The antifouling processing agent composition preferably contains an aqueous medium. As the aqueous medium, water or a mixture of water and a water-soluble organic solvent, may be mentioned, and water is preferred. As the water-soluble organic solvent, at least one member selected from the group consisting of methanol, ethanol, isopropyl alcohol, propylene glycol, propylene glycol monomethyl ether, dipropylene glycol monomethyl ether, dipropylene glycol, tripropylene glycol, tetraethylene glycol dimethyl ether, 3-methoxy-3-methyl-1-butanol, 3-methoxy-N,N-dimethylpropanamide, 3-butoxy-N,N-dimethylpropanamide and diacetone alcohol, is preferred.

The content of the polymer (A) in the antifouling processing agent composition is preferably from 0.1 to 60 mass %, more preferably from 0.5 to 50 mass %. Within the above range, water absorption, oil repellency and SR properties tend to be good.

In the antifouling processing agent composition, the mass ratio of the polymer (A) to the fluorinated amphoteric surfactant represented by the polymer (A)/fluorinated amphoteric surfactant, is preferably from 1/1 to 5/1, more preferably from 1/1 to 3/1, further preferably from 1/1 to 2/1. When the proportion of the fluorinated amphoteric surfactant is at least the lower limit value in the above range, the water absorption and SR properties tend to be good, and when it is at most the upper limit value, the washing durability and oil repellency tend to be good.

The antifouling processing agent composition produced by the above method may be diluted to a suitable solid content concentration, as the case requires.

The solid content concentration at the time of applying to the processing of an article is preferably from 0.2 to 5 mass %, more preferably from 1.0 to 3 mass %, to the total mass of the antifouling processing agent composition.

Here, the solid content concentration of the antifouling processing agent composition is calculated from the mass before heating and the mass after drying in a convection dryer at 120° C. for 4 hours.

Articles to be treated with the antifouling processing agent composition of the present invention may be fibers (natural fibers, synthetic fibers, blended fibers, etc.), various textile products, artificial leathers, non-woven fabrics, resins, filters, porous resins, paper, leathers, metals, stones, concrete, plaster, glass, etc.

As the above articles, textile products are particularly preferred. As the textile products, clothing articles (sportswear, coats, blousons, work clothing, uniforms, etc.), bags, industrial materials, etc. may be exemplified.

The treatment method may be any method so long as it is capable of adhering the antifouling processing agent composition to the surface of the article. For example, a method of applying or impregnating an antifouling processing agent composition to an article by a known coating method, followed by drying, may be mentioned.

The drying method may be normal temperature drying or heat drying. The heating and drying temperature is preferably from 40 to 200° C. In a case where the antifouling processing agent composition contains a cross-linking agent, it is preferred to heat it to a temperature higher than the cross-linking temperature of the cross-linking agent for curing, as the case requires.

The antifouling processing agent composition of the present invention contains the above-mentioned fluorinated polymer (A) and the above-mentioned fluorinated amphoteric surfactant, so that at the surface of the article treated with the antifouling processing agent composition, fluorinated groups are oriented to exhibit excellent oil repellency, and at the same time, hydrophilicity can be imparted by a fluorinated amphoteric surfactant, whereby it is possible to impart oil repellency and SR properties while suppressing a decrease in water absorption. Further, since the article and the textile product of the present invention can be provided simultaneously with oil repellency due to the fluorinated groups and hydrophilicity due to the fluorinated amphoteric surfactant, they are excellent in water absorption, oil repellency and SR properties.

### EXAMPLES

In the following, the present invention will be described in more detail with reference to Examples, but the present invention is not limited to these Examples. In the following, “%” representing the content is “mass %” unless otherwise specified.

### Measurement Methods and Evaluation Methods

### Measurement Method for Contact Angle

2 g of a liquid obtained by diluting a sample to be measured with water so that the solid content concentration becomes to be 20%, 8 g of S-LEC BL-1 (product name of SEKISUI CHEMICAL CO., LTD., a polyvinyl butyral resin) and 40 g of ethanol were mixed to obtain a treatment liquid.

As the substrate, Lumirror #100-S10 (product name of Toray Industries, Inc., a PET film, standard grade for industrial materials, thickness: 100 μm) was used, and the surface was degreased with ethanol as a pretreatment.

By using a dip coater, the treatment liquid was applied to the substrate three times at a speed of 0.5 mm/sec and then, by using a circulation oven, heat-treated to form a coating film having a thickness of at most 3 μm. The heat treatment conditions were such that after heating at 80° C. for 20 minutes, heating was performed at 110° C. for 20 minutes.

The contact angle (water contact angle, Wx, Wy) after 1 second when water (2 μL) was placed on the surface of the obtained coating film and the contact angle (n-HD contact angle, Hx, Hy) after 1 second when normal hexadecane (2 μL) was placed on the surface, were measured.

The contact angle was measured by using a portable contact angle meter PCA-1 (product name of Kyowa Interface Science Co., Ltd.) in an atmosphere at a temperature of 23° C. and a humidity of 50 RH %.

### Preparation of Test Cloth: Treatment Method for Substrate Cloth

A substrate cloth (unprocessed cloth) was immersed in 150 g of the antifouling processing agent composition obtained in each Ex. and then squeezed by a mangle, to bring the pickup rate to 65±5 mass %. Then, it was dried at 110° C. for 90 seconds and further subjected to a curing heat treatment at 170° C. for 60 seconds to obtain a test cloth.

As the substrate cloth (unprocessed cloth), a broadcloth (200 mm×200 mm) of undyed 100% cotton, was used.

The pick-up rate is the ratio of the mass difference before and after the immersion to the mass of the dried unprocessed cloth, and is calculated by the following formula (I).

Pickup rate (%)={(mass of cloth after immersion−dry mass of unprocessed cloth)/dry mass of unprocessed cloth}×100 (I)

### Evaluation Method for Water Absorption

With respect to the test cloth prepared by the above method, the water absorption was evaluated by a test method in accordance with the water absorption test method for textile products as specified in JIS L 1907 (2010).

Specifically, the test cloth is attached to the water absorption test embroidery frame, and the embroidery frame is placed on a table with the test cloth facing up. To the test cloth, from a height of 1 cm, 50 μL of a water droplet is dropped by an automatic pipette, and at the same time, a stopwatch is started. By observing visually, when the test cloth absorbs the water droplet and the specular reflection of water disappears, the stopwatch is stopped, and the time (water absorption time) is read. This operation is repeated 3 times to obtain the average value of the water absorption time. The shorter the water absorption time, the better the absorbency of the test cloth. If the specular reflection does not disappear even after 600 seconds, the test is terminated and “>600” is described as the result.

### Evaluation Method for Oil Repellency: Oil Repellency Grade (OR)

With respect to the test cloth prepared by the above method, the oil repellency was evaluated by a test method in accordance with the AATCC standard-TM118 method, and represented by the oil repellency grade shown in Table 1. The oil repellency grade is based on the wettability of eight types of hydrocarbon solvents (test liquids) having different surface tensions, to the cloth. The larger the value of this grade, the higher the oil repellency. A grade marked with + (−) indicates that the property is slightly better (poorer) as compared with the standard one of that grade. Hereinafter, this oil repellency grade is referred to as “OR”.

TABLE 1

| Oil repellency | | Surface tension (25° C.) |
|---|---|---|
| No. | Test liquid | [mN/m] |
| 8 | n-Heptane | 19.8 |
| 7 | n-Octane | 21.4 |
| 6 | n-Decane | 23.5 |
| 5 | n-Dodecane | 24.7 |
| 4 | n-Tetradecane | 26.4 |
| 3 | n-Hexadecane | 27.3 |
| 2 | 65 Parts of Nujol/35 parts of | 29.6 |
| | hexadecane | |
| 1 | Nujol | 31.2 |
| 0 | One less than 1 | — |

### Evaluation Method for Antifouling Properties (SR Properties)

With respect to the test cloth prepared by the above method, the SR properties were evaluated by a test method in accordance with the AATCC standard-TM130 method.

The test cloth prepared by the above method was spread on horizontally laid absorbent paper, and 5 drops (about 0.2 ml) of the following two types of stain liquids were dropped, glassine paper of 7.6 cm×7.6 cm was overlaid thereon, further thereon, a weight of 2.27 kg was placed, and 60 seconds later, the weight and the glassine paper were removed.

After leaving to stand at room temperature for 20 minutes, a ballast cloth was added to the test cloth to be 1.8 kg, and washing was performed at 100 g of AATCC standard detergent, 64 liters of bath volume and a bath temperature of 40° C. With respect to the test cloth after washing, the evaluation was conducted by the method as shown below.

By visually observing the degree of removal of the stain liquid, the judgment was expressed by the grade shown in Table 2. The larger the grade, the higher the SR properties. Here, one having + (−) marked to the grade of the degree of removal of the stain liquid, indicates that the respective properties are slightly better (poorer).

Corn oil (denoted as corn in the Table) and used engine oil (denoted as DMO in the Table) were used as the stain liquids in the above test.

TABLE 2

| Grade for the degree | |
|---|---|
| of removal of the stain | |
| liquid | Standards for judgement |
| 5 | Stain is completely removed. |
| 4 | Stain is attached to some extent without being |
| | removed. |
| 3 | The profile of stain is vague but the degree of |
| | removal is low. |
| 2 | The profile of stain is distinct. |
| 1 | Stain is not mostly removed. |
| 0 | Stain is not removed at all. |

### Evaluation Method for Washing Durability

Washing of the test cloth prepared by the above method was repeated 10 times in accordance with the method (water washing method) specified in No. 103 of Appendix 1 in JIS L 0217. The test cloth after washing was air-dried overnight in a constant temperature and humidity chamber at 25° C. and a humidity of 50 RH %. The evaluation result of the test cloth after air drying is shown in the column for “HL10”. The evaluation result of the test cloth that has not been washed is shown in the column for “HL0”.

### Fluorinated Amphoteric Surfactants⋅Comparative Components

The fluorinated amphoteric surfactants, the fluorinated non-amphoteric surfactants, and the comparative components of non-fluorinated surfactants, hydrophilic agents, etc. used in the following Examples are shown below.

### Fluorinated Amphoteric Surfactants

F1: Surflon S-231 (Product name of AGC Seimi Chemical Co., Ltd., specific gravity 1.30).

F2: Surflon S-232 (Product name of AGC Seimi Chemical Co., Ltd., specific gravity 1.48).

F3: Surflon S-233 (Product name of AGC Seimi Chemical Co., Ltd., specific gravity 1.48).

F4: Surflon S-234 (Product name of AGC Seimi Chemical Co., Ltd., specific gravity 1.48).

Each of F1 to 4 has a C₄₋₆ linear perfluoroalkyl group, and the number average molecular weight thereof is in the range of from 400 to 1,000.

### Fluorinated Non-Amphoteric Surfactants

F5: Surflon S-211 (Product name of AGC Seimi Chemical Co. Ltd., anionic).

F6: Surflon S-221 (Product name of AGC Seimi Chemical Co. Ltd. cationic).

F7: Surflon S-241 (Product name of AGC Seimi Chemical Co. Ltd., nonionic).

F8: Surflon S-242 (Product name of AGC Seimi Chemical Co. Ltd., nonionic).

F9: Surflon S-243 (Product name of AGC Seimi Chemical Co., Ltd., nonionic).

F10: Surflon S-386 (Product name of AGC Seimi Chemical Co., Ltd., nonionic).

The number average molecular weights of F5 to 9 are each in the range of at least 400 and less than 3,000. F10 is an oligomer having a number average molecular weight of at least 3,000.

### Comparative Components of Non-Fluorinated Surfactants, Hydrophilic Agents, Etc.

C1: Emulgen 430 (Product name of Kao Corporation, lauryl EO adduct, nonionic surfactant).

C2: CADENAX DM10D-W (Product name of Lion Corporation, dimethyldecylamine oxide, nonionic surfactant).

C3: LIPOQUARD 18-63 (Product name of Lion Corporation, stearyltrimethylammonium chloride, cationic surfactant).

C4: Emal 2F-30 (Product name of Kao Corporation, sodium lauryl sulfate, anionic surfactant).

C5: NIKKOL AM-3130N (Product name of Nikko Chemicals Co., Ltd., coconut oil fatty acid amide propyl betaine solution, amphoteric surfactant).

C6: DELECTOL AG-7 (Product name of Meisei Chemical Works, Ltd., guanidine hydrochloride type antistatic agent, cationic).

C7: PAA-HCL-01 (Product name of Nisshinbo Holdings Inc., polyallylamine, cationic).

C8: POVAL 117 (Product name of Kuraray Co., Ltd., fully saponified polyvinyl alcohol, nonionic).

C9: S-LEC BL-1 (Product name of SEKISUI CHEMICAL CO., LTD., polyvinyl acetal resin, nonionic).

The number average molecular weights of C1 to 6 are each in the range of at least 400 and less than 3,000, and the number average molecular weights of C7 to 9 are at least 3,000.

### Monomers

The monomers used in the Synthesis Examples are shown below.

### Monomer (a)

C6FMA: C₆F₁₃C₂H₄OCOC(CH₃)═CH₂.

### Monomer (b)

MEO400M: CH₂═C(CH₃)COO(EO)₉CH₃.

MEOTO800: CH₂═C(CH₃)COO-((EO)₁₀-(TO)₅)—H.

### Monomer (c)

DM: N,N-dimethylaminoethyl methacrylate.

### Monomer (d)

iso: A 3,5-dimethylpyrazole adduct of 2-isocyanate ethyl methacrylate (a compound represented by the following formula (5)).

### Monomer (e)

MA: Methacrylic acid.

AAEM: Acetoacetoxyethyl methacrylate.

[chemical structure]

The abbreviations in the following Synthesis Examples are as follows.

### Polymerization Initiator

ACP: 4,4′-Azobis(4-cyanovaleric acid).

### Chain Transfer Agent

3MP: 3-Mercaptopropionic acid.

### Nonionic Surfactant

AGE-30: Acetylene glycol ethylene oxide adduct (average number of moles of ethylene oxide added is about 30 mol).

### Synthesis Example 1: Synthesis of Polymer (A1)

Into a 1,000 mL SUS container, 128.5 g (54 parts by mass) of C6FMA, 61.7 g (26 parts by mass) of MEO400M, 38.0 g (16 parts by mass) of MEOTO800, 4.8 g (2 parts by mass) of DM, 4.8 g (2 parts by mass) of iso, 346.4 g of acetone as a polymerization solvent, 23.7 g (10 parts by mass) of AGE-30, 1.9 g (0.8 part by mass) of ACP and 1.3 g (0.55 part by mass) of 3 MP were charged and polymerized at 62° C. for 14 hours while shaking in a nitrogen atmosphere, to obtain a pale yellow solution (polymer solution) with a solid content concentration of 43.0 mass %.

To the total mass of the obtained polymer (A1), the monomer (a) units were 54 mass % and the monomer (b) units were 42 mass %.

The number average molecular weight of the obtained polymer was 210,000, and the mass average molecular weight was 650,000. Further, it was confirmed in this measurement that there was no peak derived from a monomer.

To 500 g of the obtained polymer solution, 700 g of ion-exchanged water and 1.6 g (1.1 times molar equivalent of DM) of acetic acid were added, and the mixture was stirred to carry out amine chlorination treatment. Then, acetone was removed at 55° C. under reduced pressure conditions to obtain a pale yellow transparent aqueous dispersion, and then ion-exchanged water was added to bring the solid content concentration to 20 mass %. The obtained aqueous dispersion was measured by capillary gas chromatography, and it was confirmed that the acetone content was at most 1 mass %.

### Synthesis Example 2: Synthesis of Polymer (A2)

A pale yellow solution (polymer solution) having a solid content concentration of 42.5 mass % was obtained in the same manner as in Synthesis Example 1, except that 128.5 g (54 parts by mass) of C6FMA, 61.7 g (26 parts by mass) of MEO400M, 38.0 g (16 parts by mass) of MEOTO800, 4.8 g (2 parts by mass) of MA and 4.8 g (2 parts by mass) of AAEM were used.

To the total mass of the obtained polymer (A2), the monomer (a) units were 54 mass % and the monomer (b) units were 42 mass %.

The number average molecular weight of the obtained polymer was 190,000, and the mass average molecular weight was 620,000. Further, it was confirmed in this measurement that there was no peak derived from a monomer.

To 500 g of the obtained polymer solution, 700 g of ion-exchanged water and 1.9 g (1.1 times molar equivalent of MA) of sodium hydroxide were added, and the mixture was stirred to carry out chlorination of the carboxylic acid. Next, in the same manner as in Synthesis Example 1, acetone was removed, and ion-exchanged water was added to bring the solid content concentration to 20 mass %. The obtained aqueous dispersion was measured by capillary gas chromatography, and it was confirmed that the acetone content was at most 1 mass %.

### Synthesis Example 3: Synthesis of Polymer (A3)

A pale yellow solution (polymer solution) having a solid content concentration of 43.0 mass % was obtained in the same manner as in Synthesis Example 1, except that 128.5 g (54 parts by mass) of C6FMA, 66.4 g (28 parts by mass) of MEO400M, 38.0 g (16 parts by mass) of MEOTO800, and 4.8 g (2 parts by mass) of iso were used.

To the total mass of the obtained polymer (A3), the monomer (a) units were 54 mass % and the monomer (b) units were 44 mass %.

The number average molecular weight of the obtained polymer was 230,000, and the mass average molecular weight was 690,000. Further, it was confirmed in this measurement that there was no peak derived from a monomer.

To 500 g of the obtained polymer solution, 700 g of ion-exchanged water was added, and the mixture was stirred to disperse the polymer solution and water. Next, in the same manner as in Synthesis Example 1, acetone was removed, and ion-exchanged water was added to bring the solid content concentration to 20 mass %. The obtained aqueous dispersion was measured by capillary gas chromatography, and it was confirmed that the acetone content was at most 1 mass %.

Table 3 shows results where the contact angles were measured by the above method by using, as samples to be measured, the polymers (A1) to (A3), the fluorinated amphoteric surfactants (F1) to (F4), the fluorinated non-amphoteric surfactants (F5) to (F10) and the comparative components (C1) to. (C9). Tables 4 to 7 show the value (absolute value) obtained by calculating the difference between the contact angle of the polymer (A) and the contact angle of the fluorinated amphoteric surfactant, the fluorinated non-amphoteric surfactant or the comparative component, from the values of the contact angles of water and n-HD in Table 3 with respect to the polymer (A), the fluorinated amphoteric surfactant, the fluorinated non-amphoteric surfactant and the comparative component, used in each Ex. as described later.

TABLE 3

| | | Contact angle [degree] | | | |
|---|---|---|---|---|---|
| | | Water | | n-HD | |
| Polymer (A) | A1 | Wy | 101 | Hy | 68 |
| | A2 | | 94 | | 71 |
| | A3 | | 105 | | 65 |
| Fluorinated amphoteric surfactant | F1 | Wx | 8 | Hx | 69 |
| | F2 | | 38 | | 70 |
| | F3 | | 8 | | 69 |
| | F4 | | 24 | | 71 |

| | | | |
|---|---|---|---|
| Fluorinated non-amphoteric surfactant | F5 | 29 | 74 |
| | F6 | 69 | 57 |
| | F7 | 17 | 71 |
| | F8 | 20 | 53 |
| | F9 | 9 | 57 |
| | F10 | 58 | 54 |
| Comparative component | C1 | 11 | 13 |
| | C2 | 22 | 14 |
| | C3 | 20 | 12 |
| | C4 | 16 | 15 |
| | C5 | 21 | 13 |
| | C6 | 32 | 21 |
| | C7 | 42 | 18 |
| | C8 | 65 | 20 |
| | C9 | 83 | 11 |

### Ex. 1 to 51

The respective components were mixed so as to have the compositions shown in Tables 4 to 7, and ion-exchanged water was added as the case requires to prepare an antifouling processing agent composition. The cross-linking agent g1 in the Tables is a blocked isocyanate-type cross-linking agent (Product name of Meisei Chemical Works, Ltd.: MEIKANATE TP-10) blocked with methyl ethyl ketooxime, and the cross-linking agent g2 is a blocked isocyanate-type cross-linking agent (Product name of Baxenden: Aqua BI220) blocked with 3,5-dimethylpyrazole.

The numerical values (mass %) of the contents shown in the Tables are the solid content concentrations other than the cross-linking agents (g1) and (g2), and the cross-linking agents (g1) and (g2) are tangible concentrations.

Using the antifouling processing agent composition obtained in each Ex., a test cloth was prepared by the above-described method, and the water absorption, oil repellency (OR), SR properties and washing durability were evaluated. The results are shown in the Tables.

### Ex. 52

With respect to the substrate cloth (unprocessed cloth), the results of evaluating the water absorption, oil repellency (OR), SR properties and washing durability by the above-described methods are shown in the Table.

TABLE 4

| Ex. | | | 1 | 2 | 3 | 4 | 5 | 6 | 7 | 8 | 9 | 10 | 11 | 12 | 13 |
|---|---|---|---|---|---|---|---|---|---|---|---|---|---|---|---|
| Antifouling | Polymer (A) | A1 | 1 | 0.8 | — | — | — | — | — | 1 | 1 | 0.8 | 0.8 | 0.6 | 0.6 |
| processing | | A2 | — | — | 1 | 0.8 | — | — | — | — | — | — | — | — | — |
| agent | | A3 | — | — | — | — | 1 | 1 | 0.8 | — | — | — | — | — | — |
| composition | Fluorinated | F2 | — | — | — | — | — | — | — | 0.8 | 0.6 | 0.64 | 0.48 | 0.48 | 0.36 |
| [mass %] | amphoteric | | | | | | | | | | | | | | |
| | surfactant | | | | | | | | | | | | | | |
| | Cross-linking | g1 | 1 | 1 | 1 | 1 | 1 | — | 1 | 1 | 1 | 1 | 1 | 1 | 1 |
| | agent | g2 | — | — | — | — | — | 1 | — | — | — | — | — | — | — |
| Difference in contact angle | | Water | — | — | — | — | — | — | — | 63 | 63 | 63 | 63 | 63 | 63 |
| | | n-HD | — | — | — | — | — | — | — | 2 | 2 | 2 | 2 | 2 | 2 |
| Evaluations | Water | HL0 | >600 | >600 | >600 | >600 | >600 | >600 | >600 | 8 | 10 | 5 | 5 | 8 | 9 |
| | absorption | HL10 | >600 | >600 | >600 | >600 | >600 | >600 | >600 | 24 | 23 | 11 | 10 | 12 | 13 |
| | OR | HL0 | 4 | 4 | 3 | 3 | 3 | 3 | 3 | 5 | 5 | 5 | 5 | 5 | 5 |
| | | HL10 | 3 | 3 | 2 | 2 | 3 | 3 | 3 | 2 | 2 | 2 | 2 | 2 | 2 |
| | SR properties | HL0 | 4.5 | 4.5 | 4.5 | 4.5 | 4 | 4.5 | 4.5 | 4 | 4 | 3 | 4 | 3 | 4 |
| | (corn) | HL10 | 4 | 4 | 4.5 | 4 | 3.5 | 4 | 4 | 3 | 4.5 | 4.5 | 4.5 | 4.5 | 4.5 |
| | SR properties | HL0 | 3 | 3 | 3.5 | 3 | 2.5 | 3 | 2.5 | 4.5 | 4.5 | 4.5 | 4 | 4 | 4 |
| | (DMO) | HL10 | 3.5 | 3.5 | 3.5 | 3.5 | 3 | 3.5 | 3 | 3 | 3 | 2.5 | 2.5 | 2.5 | 2.5 |

TABLE 5

| Ex. | | | 14 | 15 | 16 | 17 | 18 | 19 | 20 | 21 | 22 | 23 | 24 | 25 | 26 |
|---|---|---|---|---|---|---|---|---|---|---|---|---|---|---|---|
| Antifouling | Polymer (A) | A1 | 1 | 1 | 0.8 | 0.8 | 0.6 | 0.6 | 1 | 0.8 | 1 | 0.8 | 1 | 0.8 | 1 |
| processing | Fluorinated amphoteric | F1 | — | — | — | — | — | — | 0.6 | 0.48 | — | — | — | — | — |
| agent | surfactant | F3 | — | — | — | — | — | — | — | — | 0.6 | 0.48 | — | — | — |
| composition | | F4 | 0.8 | 0.6 | 0.64 | 0.48 | 0.48 | 0.36 | — | — | — | — | — | — | — |
| [mass %] | Fluorinated non- | F5 | — | — | — | — | — | — | — | — | — | — | 0.6 | 0.48 | — |
| | amphoteric surfactant | F6 | — | — | — | — | — | — | — | — | — | — | — | — | 0.6 |
| | Cross-linking agent | g1 | 1 | 1 | 1 | 1 | 1 | 1 | 1 | 1 | 1 | 1 | 1 | 1 | 1 |
| Difference in contact angle | | Water | 77 | 77 | 77 | 77 | 77 | 77 | 93 | 93 | 93 | 93 | 72 | 72 | 32 |
| | | n-HD | 3 | 3 | 3 | 3 | 3 | 3 | 1 | 1 | 1 | 1 | 6 | 6 | 11 |
| Evaluations | Water | HL0 | 10 | 12 | 8 | 10 | 6 | 10 | 82 | 76 | 8 | 7 | 84 | 111 | 210 |
| | absorption | HL10 | 8 | 14 | 10 | 10 | 7 | 8 | 59 | 50 | 26 | 19 | 34 | 54 | 50 |
| | OR | HL0 | 5 | 5 | 5 | 4 | 4 | 3 | 3 | 2 | 5 | 5 | 1 | 1 | 1 |
| | | HL10 | 2 | 2 | 2 | 2 | 2 | 1 | 2 | 1 | 2 | 2 | 0 | 0 | 0 |
| | SR properties | HL0 | 3 | 4 | 4 | 3 | 4 | 3 | 4 | 4 | 4.5 | 4.5 | 4 | 4 | 4 |
| | (corn) | HL10 | 4.5 | 4.5 | 4.5 | 4.5 | 4 | 4.5 | 3.5 | 3.5 | 3.5 | 3.5 | 3.5 | 3.5 | 3.5 |
| | SR properties | HL0 | 4 | 4 | 4 | 4 | 3 | 3 | 3 | 4 | 4.5 | 4 | 3 | 2.5 | 3 |
| | (DMO) | HL10 | 2 | 2 | 2 | 2 | 2.5 | 2.5 | 3.5 | 3.5 | 3.5 | 3.5 | 2 | 2 | 2.5 |

TABLE 6

| Ex. | | | 27 | 28 | 29 | 30 | 31 | 32 | 33 | 34 | 35 | 36 | 37 | 38 | 39 |
|---|---|---|---|---|---|---|---|---|---|---|---|---|---|---|---|
| Antifouling | Polymer (A) | A1 | 0.8 | 1 | 0.8 | 1 | 1 | 1 | 1 | 1 | 1 | — | — | — | — |
| processing | | A2 | — | — | — | — | — | — | — | — | — | 1 | 0.8 | — | — |
| agent | | A3 | — | — | — | — | — | — | — | — | — | — | — | 1 | 0.8 |
| composition | Fluorinated amphoteric | F1 | — | — | — | — | — | — | — | — | — | — | — | — | — |
| [mass %] | surfactant | F2 | — | — | — | — | — | — | — | — | — | 0.6 | 0.48 | 0.6 | 0.48 |
| | Fluorinated non- | F6 | 0.48 | — | — | — | — | — | — | — | — | — | — | — | — |
| | amphoteric surfactant | F7 | — | 0.6 | 0.48 | — | — | — | — | — | — | — | — | — | — |
| | | F8 | — | — | — | 0.8 | 0.4 | — | — | — | — | — | — | — | — |
| | | F9 | — | — | — | — | — | 0.8 | 0.4 | — | — | — | — | — | — |
| | | F10 | — | — | — | — | — | — | — | 1 | 0.6 | — | — | — | — |
| | Cross-linking agent | g1 | 1 | 1 | 1 | 1 | 1 | 1 | 1 | 1 | 1 | 1 | 1 | 1 | 1 |
| Difference in contact angle | | Water | 32 | 84 | 84 | 81 | 81 | 92 | 92 | 43 | 43 | 56 | 56 | 93 | 93 |
| | | n-HD | 11 | 3 | 3 | 15 | 15 | 11 | 11 | 14 | 14 | 1 | 1 | 1 | 1 |
| Evaluations | Water | HL0 | 211 | 190 | 250 | 70 | 422 | 137 | >600 | 24 | 56 | 8 | 4 | 9 | 8 |
| | absorption | HL10 | 80 | 80 | 100 | 124 | 244 | 120 | 297 | 41 | 55 | 18 | 8 | 15 | 13 |
| | OR | HL0 | 1 | 1 | 1 | 1 | 1.5 | 1 | 2 | 1 | 1 | 4 | 3 | 3 | 3 |
| | | HL10 | 0 | 0 | 0 | 0 | 0 | 0 | 0 | 0 | 0 | 1 | 1 | 2 | 1 |
| | SR properties | HL0 | 4 | 4 | 4 | 3.5 | 3.5 | 4.5 | 4.5 | 4.5 | 4.5 | 4.5 | 4 | 4.5 | 4.5 |
| | (corn) | HL10 | 3 | 3 | 3 | 4.5 | 4.5 | 4 | 4 | 4 | 4 | 4.5 | 4.5 | 4.5 | 4.5 |
| | SR properties | HL0 | 3 | 3 | 3 | 2 | 2 | 2 | 2 | 3 | 2.5 | 4.5 | 4 | 4 | 4 |
| | (DMO) | HL10 | 2.5 | 3 | 3 | 3 | 2 | 3 | 3 | 3.5 | 3.5 | 3.5 | 3 | 3.5 | 3 |

TABLE 7

| Ex. | | | 40 | 41 | 42 | 43 | 44 | 45 | 46 |
|---|---|---|---|---|---|---|---|---|---|
| Antifouling | Polymer (A) | A1 | 1 | 0.8 | 1 | 0.8 | 1 | 0.8 | 1 |
| processing | Comparative | C1 | 0.8 | 0.64 | — | — | — | — | — |
| agent | component | C2 | — | — | 0.8 | 0.64 | — | — | — |
| composition | | C3 | — | — | — | — | 0.8 | 0.64 | — |
| [mass %] | | C4 | — | — | — | — | — | — | 0.8 |
| | | C5 | — | — | — | — | — | — | — |
| | | C6 | — | — | — | — | — | — | — |
| | | C7 | — | — | — | — | — | — | — |
| | | C8 | — | — | — | — | — | — | — |
| | | C9 | — | — | — | — | — | — | — |
| | Cross-linking | g1 | 1 | 1 | 1 | 1 | 1 | 1 | 1 |
| | agent | | | | | | | | |
| Difference in contact angle | | Water | 90 | 90 | 79 | 79 | 81 | 81 | 85 |
| | | n-HD | 55 | 55 | 54 | 54 | 56 | 56 | 53 |
| Evaluations | Water | HL0 | 21 | 19 | 42 | 39 | 51 | 43 | 321 |
| | absorption | HL10 | >600 | >600 | >600 | >600 | >600 | >600 | >600 |
| | OR | HL0 | 1 | 0 | 1 | 0 | 2 | 1 | 2 |
| | | HL10 | 0 | 0 | 0 | 0 | 0 | 0 | 0 |
| | SR | HL0 | 4.5 | 4.5 | 4.5 | 4.5 | 4 | 4 | 4 |
| | properties | HL10 | 4 | 4 | 4 | 4 | 4 | 4 | 4 |
| | (corn) | | | | | | | | |
| | SR | HL0 | 4 | 4 | 4 | 4 | 3.5 | 3.5 | 4 |
| | properties | HL10 | 3.5 | 3.5 | 3.5 | 3.5 | 3 | 3 | 3 |
| | (DMO) | | | | | | | | |

| Ex. | | | 47 | 48 | 49 | 50 | 51 | 52 |
|---|---|---|---|---|---|---|---|---|
| Antifouling | Polymer (A) | A1 | 1 | 1 | 1 | 1 | 1 | Unprocessed |
| processing | Comparative | C1 | — | — | — | — | — | cloth |
| agent | component | C2 | — | — | — | — | — | |
| composition | | C3 | — | — | — | — | — | |
| [mass %] | | C4 | — | — | — | — | — | |
| | | C5 | 0.8 | — | — | — | — | |
| | | C6 | — | 0.8 | — | — | — | |
| | | C7 | — | — | 0.8 | — | — | |
| | | C8 | — | — | — | 0.8 | — | |
| | | C9 | — | — | — | — | 0.8 | |
| | Cross-linking | g1 | 1 | 1 | 1 | 1 | 1 | |
| | agent | | | | | | | |
| Difference in contact angle | | Water | 80 | 69 | 59 | 36 | 18 | — |
| | | n-HD | 55 | 47 | 50 | 48 | 57 | — |
| Evaluations | Water | HL0 | 310 | 210 | 192 | >600 | >600 | 0 |
| | absorption | HL10 | >600 | >600 | 450 | >600 | >600 | 0 |
| | OR | HL0 | 2 | 3 | 3 | 3 | 3 | 0 |
| | | HL10 | 0 | 1 | 1 | 1 | 0 | 0 |
| | SR | HL0 | 4.5 | 4.5 | 4.5 | 3.5 | 3.5 | 3 |
| | properties | HL10 | 3.5 | 4 | 3.5 | 3 | 3 | 3 |
| | (corn) | | | | | | | |
| | SR | HL0 | 3.5 | 3.5 | 3.5 | 3 | 3 | 1 |
| | properties | HL10 | 3 | 2.5 | 3 | 3 | 3 | 1 |
| | (DMO) | | | | | | | |

In Tables 4 to 7, Ex. 8 to 23 and Ex. 36 to 39 are Examples of the present invention, and Ex. 1 to 7, Ex. 24 to 35 and Ex. 40 to 52 are Comparative Examples.

The antifouling processing agent compositions in Ex. 8 to 23 and Ex. 36 to 39 were able to impart oil repellency and SR properties while suppressing a decrease in water absorption of the textile product.

This application is a continuation of PCT Application No. PCT/JP2019/039375, filed on Oct. 4, 2019, which is based upon and claims the benefit of priority from Japanese Patent Application No. 2018-191293 filed on Oct. 9, 2018. The contents of those applications are incorporated herein by reference in their entireties.

What is claimed is:

1. An antifouling processing agent composition comprising a fluorinated polymer and a fluorinated amphoteric surfactant,
wherein the fluorinated polymer comprises, to the total amount of units based on monomers constituting the fluorinated polymer, from 30 to 70 mass % of units based on a monomer represented by the following formula (1) and from 20 to 60 mass % of units based on a monomer represented by the following formula (2), and has a number average molecular weight of from 3,000 to 500,000, and
the fluorinated amphoteric surfactant has a C₁₋₆ perfluoroalkyl group or a C₃₋₉ perfluoroalkenyl group, and has a number average molecular weight of less than 3,000:
F(CF₂)ₙY—OCOCR═CH₂ (1)
CH₂═CR¹—COO—(R²O)_{q}—R³ (2)
wherein n represents an integer of 1 to 6, Y represents a C₁₋₁₀ alkylene group, R represents a hydrogen atom, a C₁₋₃ alkyl group or a halogen atom, R¹ represents a hydrogen atom or a methyl group, and R² represents a C₂₋₄ alkylene group, R³ represents a hydrogen atom, a C₁₋₈ alkyl group, a (meth)acryloyl group or a glycidyl group, and q represents an integer of 1 to 140, and in a case where q is an integer of at least 2, the plurality of —(R²O)— may be the same as or different from each other.

2. The antifouling processing agent composition according to claim 1, wherein the fluorinated polymer contains more than 0 mass % and at most 10 mass % of units based on at least one monomer selected from the group consisting of a monomer represented by the following formula (3) and a monomer represented by the following formula (4):
CH₂═CR⁴-M-Q-NR⁵R⁶ (3)
CH₂═CR⁴-M-Q-N(O)R⁵R⁶ (4)
wherein R⁴ represents a hydrogen atom or a methyl group, M represents —COO— or —CONH—, Q represents a C₂₋₄ alkylene group, or a C₂₋₃ alkylene group in which at least one of hydrogen atoms is substituted by a hydroxy group, and each of R⁵ and R⁶ independently represents a benzyl group, a C₁₋₈ alkyl group, or a C₂₋₃ alkyl group in which at least one of hydrogen atoms is substituted by a hydroxy group.

3. The antifouling processing agent composition according to claim 1, wherein the monomer represented by the formula (2) is a monomer in which the oxyalkylene group represented by the above (R²O) is an oxyethylene group.

4. The antifouling processing agent composition according to claim 1, wherein the monomer represented by the formula (2) is a monomer containing, as the oxyalkylene group represented by the above (R²O), an oxyethylene group and an oxytetramethylene group.

5. The antifouling processing agent composition according to claim 1, wherein said fluorinated polymer is a fluorinated polymer comprising units based on a monomer in which the above oxyalkylene group is an oxyethylene group and units based on a monomer in which the above oxyalkylene group is an oxyethylene group and an oxytetramethylene group.

6. The antifouling processing agent composition according to claim 5, wherein the proportion of the units based on the monomer in which the oxyalkylene group is an oxyethylene group and an oxytetramethylene group, is from 20 to 60 mass %, to the total of the units based on the monomer in which the oxyalkylene group is an oxyethylene group, and the units based on the monomer in which the oxyalkylene group is an oxyethylene group and an oxytetramethylene group.

7. The antifouling processing agent composition according to claim 1, wherein the mass ratio of the fluorinated polymer to the fluorinated amphoteric surfactant represented by the fluorinated polymer/fluorinated amphoteric surfactant, is from 1/1 to 5/1.

8. The antifouling processing agent composition according to claim 1, wherein the specific gravity of the fluorinated amphoteric surfactant is from 1.10 to 1.80.

9. The antifouling processing agent composition according to claim 1, which comprises the fluorinated polymer and the fluorinated amphoteric surfactant such that the absolute value of the difference between the contact angle of water in a PET film whose surface is treated with the fluorinated polymer and the contact angle of water in a PET film whose surface is treated with the fluorinated amphoteric surfactant, is at least 50.

10. The antifouling processing agent composition according to claim 1, which comprises the fluorinated polymer and the fluorinated amphoteric surfactant such that the absolute value of the difference between the contact angle of n-hexadecane in a PET film whose surface is treated with the fluorinated polymer and the contact angle of n-hexadecane in a PET film whose surface is treated with the fluorinated amphoteric surfactant, is at most 10.

11. An article treated with the antifouling processing agent composition as defined in claim 1.

12. A textile product treated with the antifouling processing agent composition as defined in claim 1.
